(19) United States
(12) Patent Application Publication
(10) Pub. No.: US 2013/0111013 A1
(43) Pub. Date: May 2, 2013

(54) SYSTEMS, METHODS, AND APPARATUS TO IDENTIFY MEDIA PRESENTATION DEVICES

(71) Applicant: Jan Besehanic, Tampa, FL (US)

(72) Inventor: Jan Besehanic, Tampa, FL (US)

(21) Appl. No.: 13/285,846

(22) Filed: Oct. 31, 2011

(51) Int. Cl. G06F 15/173

(52) U.S. Cl. 709/224

(57) ABSTRACT

Systems, methods, and apparatus to identify media presentation devices are disclosed. An example method includes accessing a first data set of network communications representing network communications of at least one media presentation device monitored by a network communications monitor. A second data set of network communications representing monitored network communications of at least one monitored media presentation device monitored by an on-device meter is accessed. Data is removed from the first data set based on data in the second data set to create a third data set, the third data set representing communications of at least one unmonitored media presentation device. The third data set is analyzed to identify the at least one unmonitored media presentation device.

### FIELD OF THE DISCLOSURE

This disclosure relates generally to monitoring network activity, and, more particularly, to systems, methods, and apparatus to identify media presentation devices.

### BACKGROUND

Media content providers and/or metering entities such as, for example, advertising companies, broadcast networks, etc. are often interested in the viewing, listening, and/or media behavior interests of audience members and/or the public in general. To collect these behavior interests, an audience measurement company may enlist panelists (e.g., persons agreeing to be monitored) to cooperate in an audience measurement study for a period of time. The viewing habits of these panelists as well as demographic data about the panelists is collected and used to statistically determine the size and demographics of a viewing audience.

In recent years, more consumer devices have been provided with Internet connectivity and the ability to retrieve media content from the Internet. As such, media exposure has shifted away from conventional methods of presentation, such as broadcast television, towards presentation via consumer devices accessing the Internet to retrieve media content for display.

### BRIEF DESCRIPTION OF THE DRAWINGS

FIG. 1 is a block diagram of an example system to identify media presentation devices.

FIG. 2 is a block diagram of an example configuration of the network devices shown in FIG. 1.

FIG. 3 is a block diagram of another example configuration of the network devices shown in FIG. 1.

FIG. 4 is a block diagram of an example network communications monitor to implement the network communications monitor of FIG. 1.

FIG. 5 is a block diagram of an example network activity measurement system to implement the example network activity measurement system of FIG. 1.

FIG. 6 is a flowchart representative of example machine-readable instructions which may be executed to implement the example network communications monitor of FIGS. 1 and 4 to identify network communications.

FIG. 7 is a flowchart representative of example machine-readable instructions which may be executed to implement the example network communications monitor of FIGS. 1 and/or 4 to transmit network communications.

FIG. 8 is a flowchart representative of example machine-readable instructions which may be executed to implement the example network activity measurement system of FIGS. 1 and/or 5 to identify media presentation devices.

FIG. 9 is a block diagram of an example processor platform capable of executing the example machine-readable instructions of FIGS. 6-8 to implement the example network activity measurement system of FIGS. 1 and/or 5, and/or the example network communications monitor of FIGS. 1 and/or 4.

### DETAILED DESCRIPTION

As used herein, the term “media” includes any type of content, such as television, radio, advertisements, movies, web sites, etc. Example methods, apparatus, and articles of manufacture disclosed herein identify media presentation devices and/or types of media presentation devices for media measurement. Such media presentation devices may include, for example, Internet-enabled televisions, personal computers, Internet-enabled mobile handsets (e.g., a smartphone), video game consoles (e.g., Xbox®, Playstation® 3), tablet computers (e.g., an iPad®), digital media players (e.g., a Roku® media player, a Slingbox®, etc.), etc. In some examples, identifications of media presentation devices used in consumer locations (e.g., homes, offices, etc.) are aggregated to determine ownership and/or usage statistics of available media presentation devices, relative rankings of usage and/or ownership of media presentation devices, types of uses of media presentation devices (e.g., whether a device is used for browsing the Internet, streaming media from the Internet, etc.), and/or other types of media presentation device information.

In some disclosed examples, a media presentation device includes a network interface to transmit a request for media to be presented by the media presentation device. In such examples, the media presentation device requests content from a content provider via a network (e.g., the Internet). In some examples, the request for content is a HyperText Transfer Protocol (HTTP) request, a Session Initiation Protocol (SIP) message, a domain name service (DNS) query, a file transfer protocol (FTP) request, and/or any other type of request for content.

Some networks utilize Internet Protocol (IP) for communication. The IP address scheme utilizes IP addresses assigned to network devices. For example, a network device might be assigned an IP version 4 (IPv4) address of 192.168.0.2. Any other past, present, and or future addressing scheme may additionally or alternatively be used such as, for example, IP version 6 (IPv6). In some examples, more than one IP address might be associated with a network device. For example, at a first time, the network device might be identified by an IP address of 192.168.0.2, while at a second time, the network device might be identified by an IP address of 192.168.0.3.

Internet Service Providers (ISPs) typically provide a single public IP address for each media exposure measurement location (e.g., a media presentation location, a panelist household, an internet café, an office, etc.) receiving Internet services. In some examples, multiple devices (e.g., media presentation devices) are communicatively coupled by a local area network (LAN) at a media exposure measurement location. In some examples, the LAN includes a router and/or gateway that accesses another network (e.g., the Internet) using a public IP address associated with the media exposure measurement location.

Within the LAN, individual media presentation devices are given private IP addresses by, for example, a dynamic host control protocol (DHCP.) When a media presentation device within the LAN transmits a request to a resource outside of the LAN (e.g., on the Internet,) the router and/or gateway translates the originating (private) IP address of the device making the query to the public address of the router and/or gateway before relaying the request outside of the LAN (e.g., to the Internet). Thus, when the resource outside of the LAN receives the request, the resource is able to transmit a return message (e.g., a response) to the LAN. On the return path, the router and/or gateway translates the destination IP address of the response to the private IP address of the requesting device so that the return message may be delivered to the media presentation device that made the original request.

In some examples, network resources are identified by domain names. Domain names are human readable identifiers that identify a network resource. While an IP address of a network resource might change over time, the domain name typically remains the same. Domain names typically remain the same because they are purchased by the content provider as a way for users to easily identify the service provided by the service provider. As the IP address of the content provider changes (e.g., because the content provider is now hosting their service via a different server, etc.), the domain name is updated to be associated with the most recent IP address.

While a given media exposure measurement location can be identified by the public IP address assigned by the ISP, individual devices within the media exposure measurement location cannot be identified as easily. To identify media presentation devices within the media exposure measurement location, a network communications monitor and, in some examples described herein, monitored network devices are used in the media exposure measurement location.

In some examples, monitored network devices are used within the media exposure measurement location. Monitored network devices are devices which are monitored (individually or otherwise) by some form of monitoring system. The monitored network device may be, for example, a personal computer, a smart phone, a tablet, etc. In some examples, the monitored device is monitored by an on-device meter that collects monitoring information regarding the network communications and/or activities of the monitored network device. In some examples, the on-device meter collects information in addition to the network communications of the monitored network device such as, for example, indicia of user input, indicia of information presented by the monitored network device, etc.

In some examples, the on-device meter operating on a monitored network device captures network communications to and/or from the monitored network device and creates a log and/or record of the network communications. The log and/or record of the network communications may then be transmitted to a monitoring entity for analysis. In some examples, the log of network communications is electronically transmitted to the monitoring entity via a network such as, for example, the Internet. However, the log of network communications may be transmitted by physically mailing the log (e.g., as a printout, an electronic copy, etc.)

In some examples, the network devices are not capable of being monitored by an on device meter. For example some network devices do not allow for installation of third-party software (e.g., an on-device meter). Further, because of the many types of network devices available, maintaining software packages for every type of network device is difficult. Because installation of a monitoring system on all types of network devices is difficult, if not impossible, network devices may go unmonitored.

In some examples, a network communications monitor is used to capture network communications of all devices on the network. The network communications monitor is installed at the media exposure measurement location and identifies network communications to and/or from network devices within the media exposure measurement location (e.g., the communications of devices sharing a public IP address via, for example, a gateway). Thus, the network communications monitor monitors all network devices within the media exposure measurement location. The network communications monitor creates a log and/or a record of the network communications and transmits the log and/or the record to the network activity measurement system. As described above, the log of network communications created by the network communications monitor may be transmitted by physically mailing the log.

Some example methods, apparatus, and articles of manufacture disclosed herein are located at a media exposure measurement location having one or more media presentation devices. Some of these example methods, apparatus, and articles of manufacture are interposed between the media presentation devices and a wide area network (WAN), such as the Internet, that includes one or more content providers that provide media content in response to request(s) from the media presentation devices. Some example methods, apparatus, and articles of manufacture disclosed herein intercept messages to and/or from the WAN (e.g., media requests from media presentation devices on the same LAN as the intercepting method, apparatus, or article of manufacture.)

Some example methods, apparatus, and articles of manufacture disclosed herein inspect the network communications to determine if the network communications should be recorded. For example, when the network communications monitor identifies HTTP requests, the network communications are transmitted to a network activity measurement system and/or stored for transmission to the network activity measurement system at a later time. Some such example methods, apparatus, and articles of manufacture additionally or alternatively determine ownership and/or usage statistics based on messages from the WAN to the media presentation devices on the LAN. Some example methods, apparatus, and articles of manufacture disclosed herein determine the type(s) of media presentation device based on the network communications (e.g., via HTTP queries contained in the communications) but, unlike media content providers that track usage statistics, do not return content to the media presentation device(s) in response to the network communications.

In some examples, to analyze network communications of unmonitored network devices, network communications from monitored devices are filtered out of communications of all devices. Thus, communications of unmonitored network devices can be identified and/or analyzed. Such analysis may include inspecting the network communications of the unmonitored network devices to for example, determine a type of an unmonitored network device involved in the network communications, identify requests made by the unmonitored network device, etc.

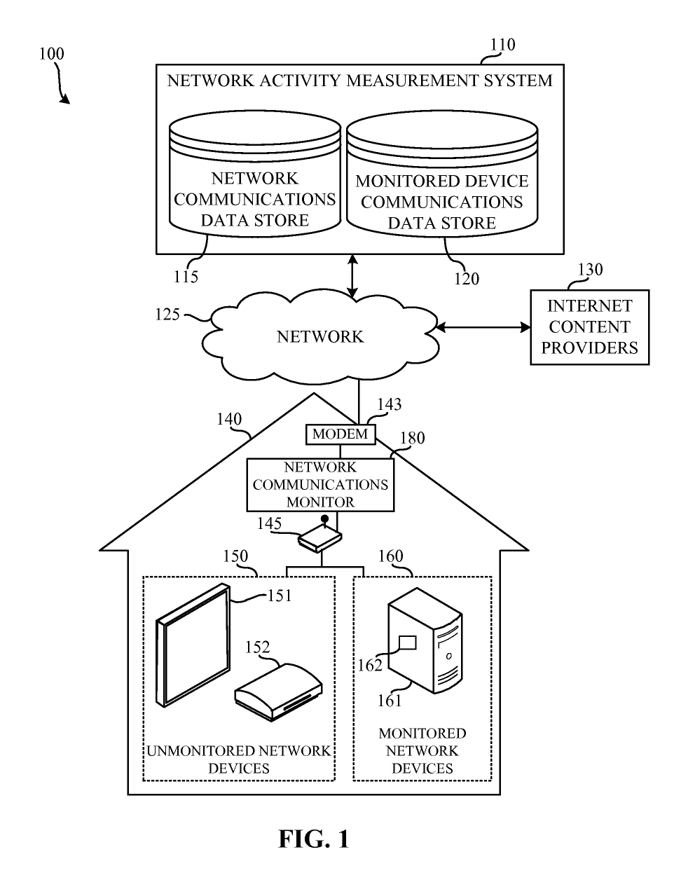

FIG. 1 is a block diagram of an example system 100 to identify media presentation devices. The example system of FIG. 1 includes a network activity measurement system 110, and a network communications monitor 180 to monitor communications across a network 125. Further shown are an example media exposure measurement location 140, example Internet content providers 130, an example network gateway 145, an example modem 143, example unmonitored network devices 150, and example monitored network devices 160. In the illustrated example, the unmonitored network devices 150 and the monitored network devices 160 are media presentation devices.

The network activity measurement system 110 of the illustrated example is a server that collects and processes network communications from the media presentation devices 150 and 160 to generate media presentation device information. The network activity measurement system 110 analyzes the network communications to identify, for example, which media presentation devices are the most owned, the most-frequently used, the least-frequently owned, the least-frequently used, the most/least-frequently used for particular type(s) and/or genre(s) of media, and/or any other media statistics or aggregate information that may be determined from the data. The media presentation device information may also be correlated or processed with factors such as geodemographic data (e.g., a geographic location of the media exposure measurement location, age(s) of the panelist(s) associated with the media exposure measurement location, an income level of a panelist, etc.) Media presentation device information may be useful to manufacturers and/or advertisers to determine which features should be improved, determine which features are popular among users, identify geodemographic trends with respect to media presentation devices, identify market opportunities, and/or otherwise evaluate their own and/or their competitors' products.

The network activity measurement system 110 of the illustrated example includes a network communications data store 115 and a monitored device communications data store 120. The network communications data store 115 of the illustrated example stores network communications monitored by the network communications monitor 180. Thus, the network communications data store 115 includes network communications of the unmonitored network devices 150 and network communications of the monitored network devices 160. The monitored device communications data store 120 stores network communications of the monitored network devices 160. The network communications of the monitored network devices 160 are transmitted to the monitored device communications data store 120 by monitoring systems (e.g., on-device meters) on the monitored network devices 160. In the illustrated example, the monitored network device 161 is a personal computer that includes an on-device meter 162. The on-device meter 162 of the personal computer 161 monitors network communications of the personal computer 161 and transmits those communications to the monitored device communications data store 120.

The network 125 of the illustrated example of FIG. 1 is a wide area network (WAN) such as the Internet. However, in some examples, local networks may additionally or alternatively be used. For example, multiple networks may be utilized to couple the components of the example system 100 to identify media presentation devices.

In the illustrated example, the media exposure measurement location 140 includes unmonitored network devices 150, as well as monitored network devices 160. In the illustrated example, the monitored network devices 160 include measurement systems such as, for example, an on-device meter 162. In contrast, the unmonitored network devices 150 of the illustrated example do not include such measurement systems. Thus, the unmonitored network devices 150 are monitored by the network communications monitor 180. The unmonitored network devices 150 and the monitored network devices 160 are collectively referred to herein as media presentation devices 150 and 160.

The media presentation devices 150 and 160 of FIG. 1 are devices that retrieve content from the Internet content providers 130 for presentation at the media exposure measurement location 140. In some examples, the media presentation devices 150 and 160 are capable of directly presenting media (e.g., via a display) while, in some other examples, the media presentation devices 150 and 160 present the media on separate media presentation equipment (e.g., speakers, a display, etc.). The media presentation device 151 of the illustrated example is an Internet enabled television, and thus, is capable of directly presenting media (e.g., via an integrated display and speakers). The media presentation device 152 of the illustrated example is a gaming console (e.g., Xbox®, Playstation® 3, etc.) and requires additional media presentation equipment (e.g., a television) to present media. The media presentation device 161 of the illustrated example is a personal computer. While, in the illustrated example, an Internet enabled television, a gaming console, and a personal computer are shown, any other type(s) and/or number(s) of media presentation device(s) may additionally or alternatively be used. For example, Internet-enabled mobile handsets (e.g., a smartphone), tablet computers (e.g., an iPad®,) digital media players (e.g., a Roku® media player, a Slingbox®, etc.,) etc. may additionally or alternatively be used. Further, while in the illustrated example three media presentation devices are shown, any number of media presentation devices may be used.

The Internet content providers 130 of the illustrated example of FIG. 1 are servers providing Internet content (e.g., web pages, videos, images, etc.). The Internet content providers 130 may be implemented by any provider(s) of media content such as a digital broadcast provider (cable television service, fiber-optic television service, etc.) and/or an on-demand digital content provider (e.g., Internet streaming video and/or audio services such as Netflix®, YouTube®, Hulu®, Pandora®, Last.fm®,) and/or any other provider of streaming media services. In some other examples, the Internet content providers 130 are hosts for web site(s). Additionally or alternatively, the content providers 130 may not be on the Internet. For example, the content providers may be on a private and/or semi-private network (e.g., a LAN.)

The media exposure measurement location 140 of the illustrated example of FIG. 1 is a panelist household. However, the media exposure measurement location 140 may be any other location, such as, for example an internet café, an office, an airport, a library, a non-panelist household, etc. While in the illustrated example a single media exposure measurement location 140 is shown, any number and/or type(s) of media exposure measurement locations may be used.

The modem 143 of the illustrated example of FIG. 1 is a modem that enables network communications of the media exposure measurement location 140 to reach the network 125. In some examples, the modem 143 is a digital subscriber line (DSL) modem, while in some other examples the modem 143 is a cable modem. In some examples, the modem 143 is a media converter that converts one communications medium (e.g., electrical communications, optical communications, wireless communications, etc.) into another type of communications medium. In the illustrated example, the modem 143 is separate from the network gateway 145. However, in some examples, the modem 143 may be a part of (e.g., integral to) the network gateway 145.

The example network gateway 145 of the illustrated example of FIG. 1 is a router that enables the media presentation devices 150 and 160 to communicate with the network 125 (e.g., the Internet.) In some examples, the example network gateway 145 includes gateway functionality such as modem capabilities. In some other examples, the example network gateway 145 is implemented in two or more devices (e.g., a router, a modem, a switch, a firewall, etc.).

In some examples, the example network gateway 145 hosts a LAN for the media exposure measurement location 140. In the illustrated example, the LAN is a wireless local area network (WLAN), and allows the media presentation devices 150, 155, and 160 to transmit and receive data via the Internet. Alternatively, the network gateway 145 may be coupled to such a LAN.

The network communications monitor 180 of the illustrated example of FIG. 1 is a network device interposed between the LAN hosted by the example network gateway 145 and the network 125. Additionally or alternatively, the network communications monitor 180 may be a device on the LAN. The network communications monitor 180 of the illustrated example identifies network communications from the media presentation devices 150 and 160 within the media exposure measurement location 140. The network communications monitor 180 creates a record (e.g., a log) identifying which of the media presentation device(s) 150 and/or 160 were involved in which of the network communications and transmits the record to the network activity measurement system 110. In some examples, the network communications monitor 180 determines which device was involved in the network communications by inspecting the network communications passing through the network communications monitor 180.

In some examples, the example network gateway 145 permits custom firmware and/or software to be loaded and/or executed. In some such examples, the network gateway 145 may be provided with firmware and/or software that, in addition to standard routing and/or modem behavior, monitors messages or data packets directed from the media presentation devices 150 and 160 to the network 125 and/or directed from the network 125 to the media presentation devices 150 and 160. Additionally or alternatively, such monitoring functionality may be part of a separate device such as, for example, the network communications monitor 180.

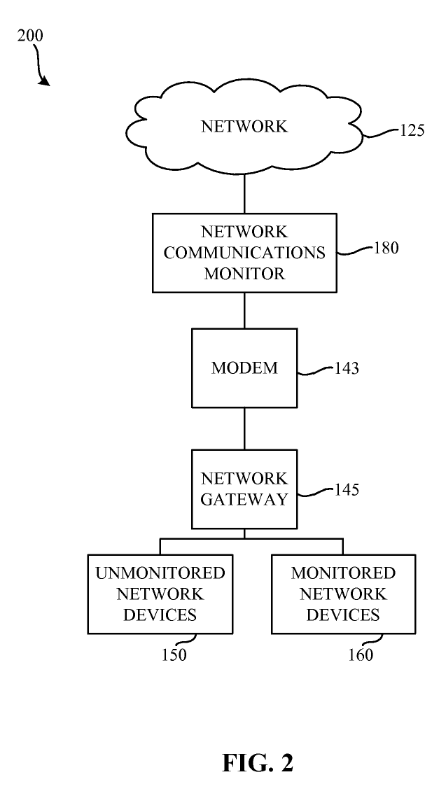

FIG. 2 is a block diagram of an example configuration 200 of the network devices shown in FIG. 1. In the example configuration 200 of the illustrated example, the network communications monitor 180 is placed between the network 125 and the modem 143. The modem 143 communicates with the network gateway 145, which in turn communicates with the media presentation devices 150 and 160.

In the illustrated example, the network communications monitor 180 monitors communications between the modem 143 and the network 125. For example, when the modem 143 is a DSL modem the network communications monitor 180 monitors the DSL communications. In the illustrated example, the network communications monitor 180 includes one or more ports (e.g., a DSL port, a cable port, etc.) for receiving and/or transmitting network communications.

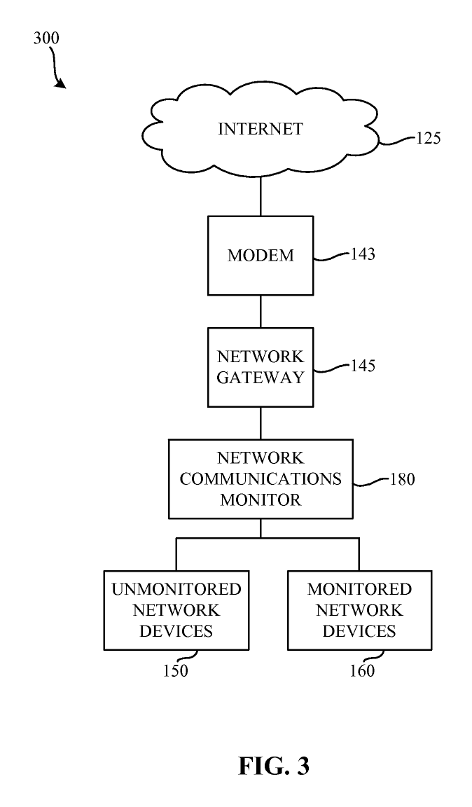

FIG. 3 is a block diagram of another example configuration 300 of the network devices shown in FIG. 1. In the example configuration 300 of FIG. 3, the network communications monitor 180 is placed between the network gateway 145 and the media presentation devices 150 and 160. Thus, the modem 143 communicates with the network gateway 145. The network gateway 145 communicates with the media presentation devices 150 and 160, and those communications pass through the network communications monitor 180.

In the illustrated example of FIG. 3, the network communications monitor 180 monitors communications between the network gateway 145 and the media presentation devices 150 and 160. In some examples, the network communications monitor 180 is a network routing device (e.g., a router, a switch, a hub, etc.) that monitors network communications. In the illustrated example, because the modem 143 and the network gateway 145 are adjacent, they may be combined into a single device. For example, a combined gateway and modem device may additionally or alternatively be used.

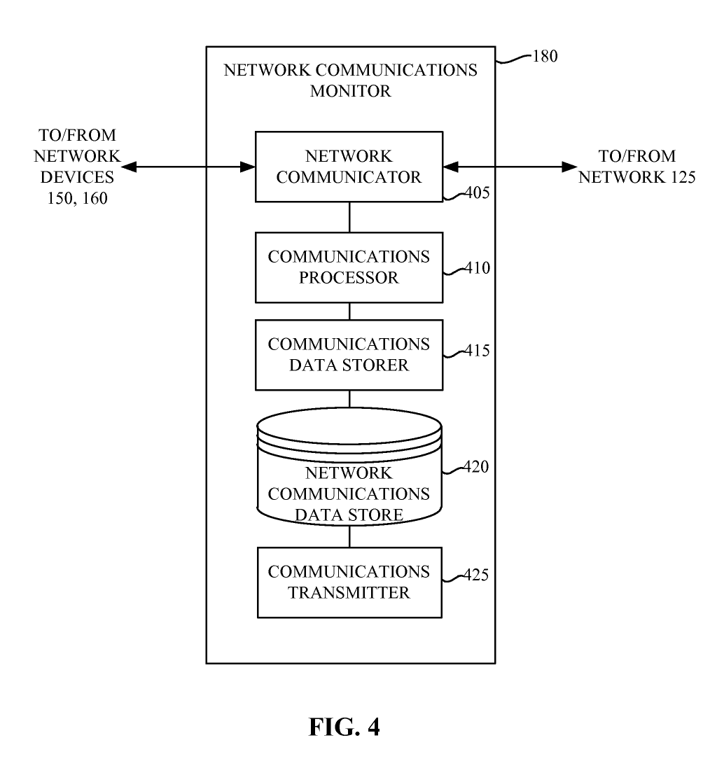

FIG. 4 is a block diagram of an example network communications monitor 180 to implement the network communications monitor 180 of FIG. 1. The example network communications monitor 180 of FIG. 4 includes a network communicator 405, a communications processor 410, a communications data storer 415, a communications data store 420, and a communications transmitter 425.

The network communicator 405 of the illustrated example of FIG. 4 is an Ethernet interface. In the illustrated example, the network communicator 410 receives network communications (e.g., HTTP requests, etc.) from the network gateway 145, the media presentation devices 150 and/or 160, and/or the modem 143. The network communicator 405 transmits the network communications to the network 125, and receives and/or transmits network communications in the reverse path (e.g., towards the LAN). While in the illustrated example, the network communicator 405 is an Ethernet interface, any other type of interface may additionally or alternatively be used. For example, the network communicator 405 might include one or more of a Bluetooth interface, a WiFi interface, a digital subscriber line (DSL) interface, a T1 interface, etc. While in the illustrated example a single network communicator 405 is shown, any number and/or type(s) of network communicators may additionally or alternatively be used. For example, two network communicators (e.g., Ethernet interfaces) may be used. In such an example, a first network communicator may receive and/or transmit network communications to and/or from the network gateway 145 while a second network communicator may receive and/or transmit network communications to and/or from the network 125.

The communications processor 410 of the illustrated example of FIG. 4 inspects network communications received by the network communicator 405. The example communications processor 410 of FIG. 4 is implemented by a processor executing instructions, but it could alternatively be implemented by an Application Specific Integrated Circuit (ASIC), Digital Signal Processor (DSP), Field Programmable Gate Array (FPGA), or other circuitry. In the illustrated example, the communications processor 410 filters network communications received by the network communicator 405 to identify network communications of the media presentation devices 150 and/or 160. Further, the communications processor 410 identifies the media presentation device 150 and/or 160 involved in the network communications.

The communications data storer 415 of the illustrated example of FIG. 4 stores network communications identified by the communications processor 410 in the network communications data store 420. The example data storer 415 of the illustrated example is implemented by a processor executing instructions, but it could alternatively be implemented by an ASIC, DSP, FPGA, or other circuitry. The communications processor 410 and the data storer 415 may be implemented by the same physical processor. In the illustrated example, network communications identified by the communications processor 410 are stored in association with the media presentation device(s) 150 and/or 160 identified as receiving and/or transmitting a network communications.

The network communications data store 420 of the illustrated example of FIG. 4 may be any device for storing data such as, for example, flash memory, magnetic media, optical media, etc. Furthermore, the data stored in the network communications data store 420 may be in any data format such as, for example, binary data, comma delimited data, tab delimited data, structured query language (SQL) structures, etc. While, in the illustrated example, the network communications data store 420 is illustrated as a single database, the network communications data store 420 may be implemented by any number and/or type(s) of databases.

The communications transmitter 425 of the illustrated example of FIG. 4 transmits network communications data stored in the network communications data store 420. In the illustrated example, the communications transmitter 425 is implemented by a processor executing instructions, but it could alternatively be implemented by an ASIC, DSP, FPGA, or other circuitry. The communications transmitter 425 may be implemented on the same physical processor as the communications processor 410 and/or the communications data storer 415. The communications transmitter 425 of the illustrated example periodically and/or a-periodically transmits network communications data from the network communications data store 420 to the network activity measurement system 110.

The example communications transmitter 425 may transmit the network communications data upon determining that the amount of network communications data stored in the network communication data store 420 has reached a threshold, and/or in response to a clock (e.g., a time limit specifying that network communications are transmitted once every day). Transmitting network communications every day ensures that there is little lag time between the occurrence of the network communications and the ability to analyze the network communications. However, the transmission may occur at any desired interval(s) such as, for example, transmitting once every hour, once every week, etc. In examples in which the transmission is triggered based on an amount of network communications data stored in the network communications data store 420, the transmission threshold might indicate that network communications should be transmitted if there is more than a predetermined amount (e.g., one megabyte) of network communications data stored in the network communications data store 420. Any data storage amount may be used for such a trigger such as, for example, ten megabytes, one hundred megabytes, etc. Additionally or alternatively, multiple transmission thresholds may be present. For example, a threshold indicating that network communications data should be transmitted at least once a day and a threshold indicating that network communications data should be transmitted if more than one megabyte of network communications data is stored in the network communications data store 420 might be used.

In the illustrated example, the communications transmitter 425 transmits the network communications data via the network 125. However, the communications transmitter 425 may transmit network communications data via any other communication medium. For example, the network communications monitor 180 may be physically mailed to the network activity measurement system 110 and the communications transmitter 425 might transmit network communications data via, for example, a USB connection, a Bluetooth connection, a serial connection, a local area network (LAN), etc.

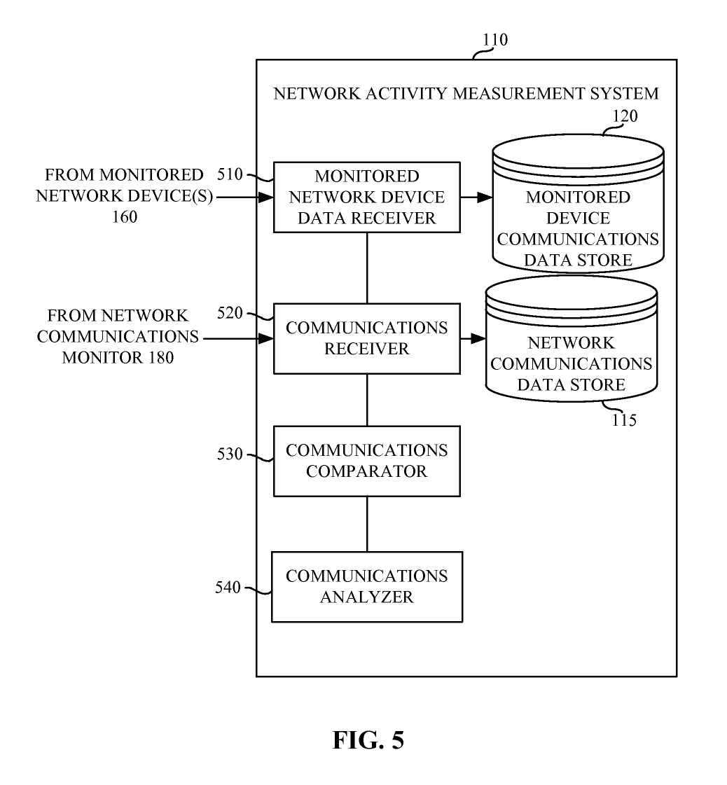

FIG. 5 is a block diagram of an example network activity measurement system 110 to implement the example network activity measurement system 110 of FIG. 1. The example network activity measurement system 110 of FIG. 5 includes a monitored network device data receiver 510, a communications receiver 520, a communications comparator 530, a communications analyzer 540, the network communications data store 115, and the monitored device communications data store 120.

The monitored network device data receiver 510 of the illustrated example of FIG. 5 receives network communications of the monitored network devices 160. In the illustrated example, the network device data receiver 510 is implemented by a processor executing instructions, but it could alternatively be implemented by an ASIC, DSP, FPGA, or other circuitry. In the illustrated example, the network communications of the monitored network devices 160 are initially monitored by the on-device meter of the monitored network devices 160 and then transmitted to the network activity measurement system 110. In some examples, the on-device meter of the monitored network devices 160 transmits the network communications to a system other than the network activity measurement system 110. Thus, the monitored network device data receiver 510 may retrieve the network communications of the monitored network devices 160 from the system other than the network activity measurement system 110. Additionally or alternatively, the system other than the network activity measurement system 110 may transmit the network communications of the monitored network devices 160 to the monitored network device data receiver 510 without the network communications being requested by the monitored network device data receiver 510.

The monitored device communications data store 120 of the illustrated example of FIG. 5 may be any device for storing data such as, for example, flash memory, magnetic media, optical media, etc. Furthermore, the data stored in the monitored device communications data store 120 may be in any data format such as, for example, binary data, comma delimited data, tab delimited data, structured query language (SQL) structures, etc. While, in the illustrated example, the monitored device communications data store 120 is illustrated as a single database, the monitored device communications data store 120 may be implemented by any number and/or type(s) of databases.

The communications receiver 520 of the illustrated example of FIG. 5 receives network communications data from the example network communications monitor 180 shown in FIGS. 1 and 4. In the illustrated example, the communications data receiver 520 is implemented by a processor executing instructions, but it could alternatively be implemented by an ASIC, DSP, FPGA, or other circuitry. The communications receiver 520 and the network device data receiver 510 may be implemented on the same physical processor. In the illustrated example, the communications receiver 520 receives the network communications from the network communications monitor 180 via a network interface (e.g., an Ethernet connection). However, the communications receiver 520 may receive the network communications from the network communications monitor 180 via any other type of interface such as, for example, a universal serial bus (USB) connection, a Bluetooth connection, etc. The communications receiver 520 of the illustrated example stores the received network communications in the network communications data store 115.

The network communications data store 115 of the illustrated example of FIG. 5 may be implemented by any type(s) and number of device(s) for storing data such as, for example, flash memory, magnetic media, optical media, etc. Furthermore, the data stored in the network communications data store 115 may be in any data format(s) such as, for example, binary data, comma delimited data, tab delimited data, structured query language (SQL) structures, etc. While, in the illustrated example, the network communications data store 115 is illustrated as a single database, the network communications data store 115 may be implemented by any number and/or type(s) of databases.

The communications comparator 530 of the illustrated example of FIG. 5 compares communications stored in the network communications data store 115 with communications stored in the monitored device communications data store 120. In the illustrated example, the communications comparator 530 is implemented by a processor executing instructions, but it could alternatively be implemented by an ASIC, DSP, FPGA, or other circuitry. The communications comparator 530 may be implemented on the same physical processor as the network device data receiver 510 and/or the communications receiver 520. In the illustrated example, the network communications data store 115 stores data representing communications from the unmonitored network devices 150 and the monitored network devices 160; whereas the monitored device communications data store 120 stores data representing communications from the monitored network devices 160 and does not store data representing communications of the unmonitored network devices 150. The example communications comparator 530 of FIG. 5filters communications stored in the network communications data store 115 based on the communications stored in the monitored device communications data store 120 to create a subset of communications representing communications from the unmonitored network devices 150.

The communications analyzer 540 of the illustrated example of FIG. 5 analyzes the subset of communications representing communications from the unmonitored network devices 150. In the illustrated example, the communications analyzer 540 is implemented by a processor executing instructions, but it could alternatively be implemented by an ASIC, DSP, FPGA, or other circuitry. The communications analyzer 540 may be implemented on the same physical processor as the network device data receiver 510, the communications receiver 520, and/or the communications comparator 530. The example communications analyzer 540 analyzes the communications from the unmonitored network devices 150 to determine, for example, ownership and/or usage statistics of the unmonitored network devices 150, relative rankings of usage and/or ownership of unmonitored network devices 150, type(s) of uses of unmonitored network devices 150 (e.g., whether a device is used for browsing the Internet, streaming media from the Internet, etc.), and/or other type(s) of unmonitored network device information.

While an example manner of implementing the network activity measurement system 110 of FIG. 1 has been illustrated in FIG. 5 and an example manner of implementing the network communications monitor 180 of FIG. 1 has been illustrated in FIG. 4, one or more of the elements, processes and/or devices illustrated in FIGS. 4 and/or 5 may be combined, divided, re-arranged, omitted, eliminated and/or implemented in any other way. Further, the example network communicator 405, the example communications process 410, the example communications data storer 415, the example network communications data store 420, the example communications transmitter 425, and/or, more generally, the example network communications monitor 180 of FIGS. 1 and 4 and/or the example monitored network device data receiver 510, the example monitored device communications data store 120, the example communications receiver 520, the example network communications data store 115, the example communications comparator 530, the example communications analyzer 540, and/or, more generally, the example network activity measurement system 110 of FIGS. 1 and 5 may be implemented by hardware, software, firmware and/or any combination of hardware, software and/or firmware. Thus, for example, any of the example network communicator 405, the example communications process 410, the example communications data storer 415, the example network communications data store 420, the example communications transmitter 425, and/or, more generally, the example network communications monitor 180 of FIGS. 1 and 4 and/or the example monitored network device data receiver 510, the example monitored device communications data store 120, the example communications receiver 520, the example network communications data store 115, the example communications comparator 530, the example communications analyzer 540, and/or, more generally, the example network activity measurement system 110 of FIGS. 1 and 5 could be implemented by one or more circuit(s), programmable processor(s), application specific integrated circuit(s) (ASIC(s)), programmable logic device(s) (PLD(s)) and/or field programmable logic device(s) (FPLD(s)), etc.

When any of the apparatus and/or system claims of this patent are read to cover a purely software and/or firmware implementation, at least one of the example network communicator 405, the example communications process 410, the example communications data storer 415, the example network communications data store 420, the example communications transmitter 425, and/or, more generally, the example network communications monitor 180 of FIGS. 1 and 4 and/or the example monitored network device data receiver 510, the example monitored device communications data store 120, the example communications receiver 520, the example network communications data store 115, the example communications comparator 530, the example communications analyzer 540, and/or, more generally, the example network activity measurement system 110 of FIGS. 1 and 5 are hereby expressly defined to include a tangible machine-readable medium such as a memory, DVD, CD, Blu-ray, etc. storing the software and/or firmware. Further still, the example network activity measurement system 110 of FIGS. 1 and 5 and/or the example network communications monitor 180 of FIGS. 1 and 4 may include one or more elements, processes and/or devices in addition to, or instead of, those illustrated in FIGS. 1, 4, and/or 5, and/or may include more than one of any or all of the illustrated elements, processes and devices.

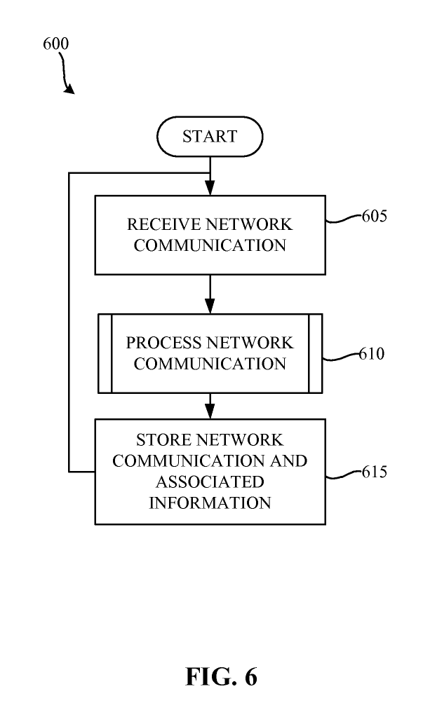

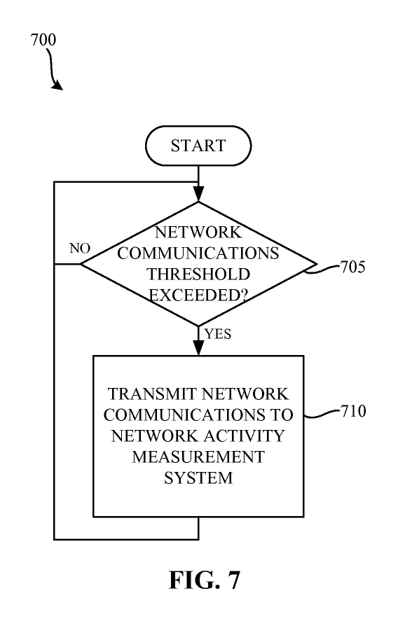

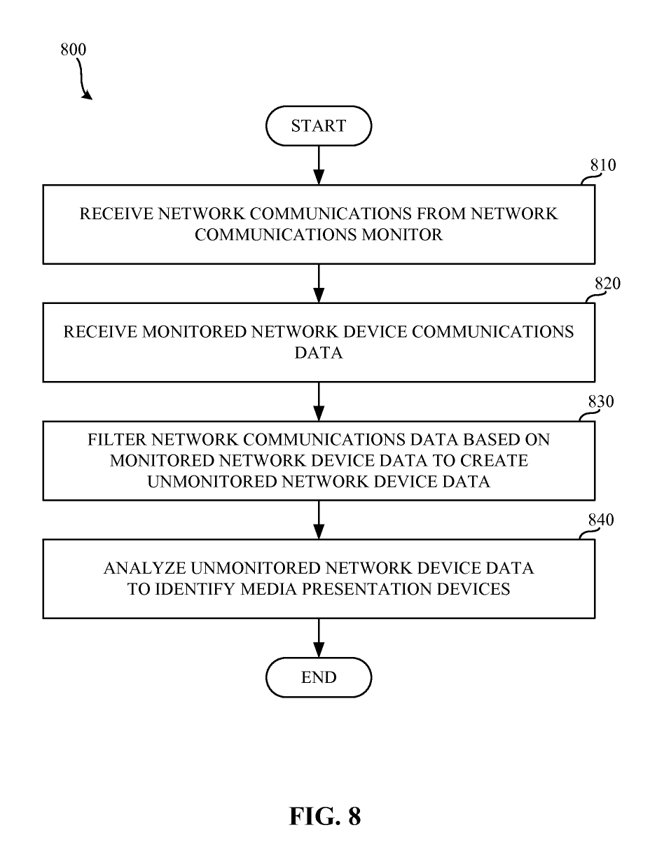

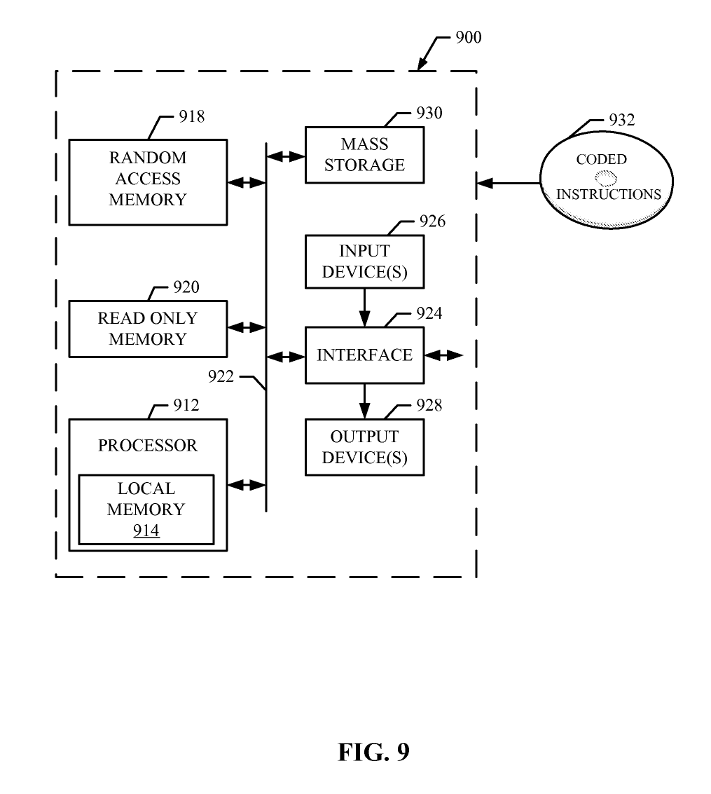

Flowcharts representative of example machine-readable instructions for implementing the example network communications monitor 180 of FIGS. 1 and 4 are shown in FIGS. 6 and 7. Further, flowcharts representative of example machine-readable instructions for implementing the example network activity measurement system 110 of FIGS. 1 and 5 are shown in FIG. 8. In these examples, the machine-readable instructions comprise programs for execution by a processor such as the processor 912 shown in the example processor system 900 discussed below in connection with FIG. 9. The program may be embodied in software stored on a machine-readable medium such as a CD-ROM, a floppy disk, a hard drive, a digital versatile disk (DVD), or a memory associated with the processor 912, but the entire program and/or parts thereof could alternatively be executed by a device other than the processor 912 and/or embodied in firmware or dedicated hardware. Further, although the example programs are described with reference to the flowcharts illustrated in FIGS. 6 through 8, many other methods of implementing the example network activity measurement system 110 of FIGS. 1 and 5 and/or the example network communications monitor 180 of FIGS. 1 and 4 may alternatively be used. For example, the order of execution of the blocks may be changed, and/or some of the blocks described may be changed, eliminated, or combined.

As mentioned above, the example processes of FIGS. 6 through 8 may be implemented using coded instructions (e.g., machine-readable instructions) stored on a tangible machine-readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible machine-readable medium is expressly defined to include any type of machine-readable storage and to exclude propagating signals. Additionally or alternatively, the example processes of FIGS. 6 through 8 may be implemented using coded instructions (e.g., machine-readable instructions) stored on a non-transitory machine-readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory machine-readable medium is expressly defined to include any type of machine-readable medium and to exclude propagating signals.

FIG. 6 is a flowchart representative of example machine-readable instructions 600 which may be executed to implement the example network communications monitor 180 of FIGS. 1 and 4 to monitor network communications. The machine-readable instructions 600 of FIG. 6 begin execution when the network communicator 405 receives network communications (block 605). In the illustrated example, the network communicator 405 receives network communications sent from the network gateway 145 to the network 125. However, in some examples, the network communicator 405 also receives network communications sent from the network 125 to the network gateway 145.

The communications processor 410 then inspects the received network communications to determine whether to store the received network communications (block 610). In the illustrated example, the communications processor 410 inspects the network communications to identify HTTP communications. In such an example, the HTTP communications are stored in the network communications data store 520 by the communications data storer 415.

In some examples, the communications processor 410 inspects the network communications to identify a type and/or protocol of network communication (e.g., HTTP communications, DNS communications, SIP communications, FTP communications, etc.) In some examples, the communications processor 410 inspects the network communications to identify a source and/or a destination of the network communications. In such an example, communications might only be stored when they are requests transmitted to particular Internet content providers (e.g., Netflix®, YouTube®, Hulu®, Pandora®, Last.fm®, etc.) and/or when the communications originated from a particular type of unmonitored network device (e.g., an Internet enabled television, a video game console, etc.).

In some examples, the communications processor 410 processes the received network communications to identify particular portion(s) of the network communications. For example, to reduce the amount of storage space required to store the network communications, the communications processor 410 may remove and/or compress one or more portion(s) of the network communications.

Once the communications have been processed by the communications processor 410, the communications are stored in the network communications data store 410 by the communications data storer 415 (block 615).

FIG. 7 is a flowchart representative of example machine-readable instructions 700 which may be executed to implement the example network communications monitor 180 of FIGS. 1 and 4 to transmit stored network communications. The machine-readable instructions 700 of FIG. 7 begin execution at block 705 when the communications transmitter 425 determines whether a network communications threshold has been exceeded (block 705). In the illustrated example, the threshold is a time limit specifying that network communications are transmitted once every day. Additionally or alternatively, any other periodic and/or aperiodic approach to transmitting network communications from the network communications monitor 180 may be used. For example, the network communications threshold might be based on an amount of network communications data stored in the network communications data store 420.

If the network communications threshold has not been exceeded (block 705) the communications transmitter 425 continues to determine whether the network communications have exceeded the network communications threshold. When the network communications threshold has been exceeded (block 705), the communications transmitter 425 transmits the stored network communications to the network communications data receiver 340 of the network activity measurement system 110 as a log of network activity. In the illustrated example, the communications transmitter 425 transmits the stored network communications via the network communicator 405. However, in some examples, the communications transmitter 425 transmits the stored network communications via a local connection such as, for example, a serial connection, a universal serial bus (USB) connection, a Bluetooth connection, etc. When the communications transmitter 425 transmits via the local connection, the network communications monitor 180 may be physically moved to a location of the network activity measurement system 110 by, for example, physically mailing the network communications monitor 180, etc.

FIG. 8 is a flowchart representative of example machine-readable instructions 800 which may be executed to implement the example network activity measurement system 110 of FIGS. 1 and 5 to identify media presentation devices. In particular, the example flowchart of FIG. 8 illustrates an example process wherein the network activity measurement system 110 receives network communications from the network communications monitor 180 and the monitored network devices 160, filters the network communications, and analyzes the filtered network communications to identify media presentation devices. The example machine-readable instructions 800 of FIG. 8 begin execution when the communications receiver 520 receives network communications from the network communications monitor 180 (block 810). In the illustrated example, the network communications are received from the network communications monitor 180 via a network connection, such as, for example, the Internet. However, the network communications data may be received in any other fashion. For example, the network communications data may be received via a universal serial bus (USB) connection. In such an example, the network communications monitor 180 may be mailed to a location of the network activity measurement system 110. Additionally or alternatively a storage device (e.g., a memory stick, a compact disk, a hard disk drive, etc.) may be mailed and/or otherwise sent to the network activity measurement system. Upon receiving the network communications data, the communications receiver 520 stores the network communications in the network communications data store 115.

The monitored network device data receiver 510 receives monitored network device communications data (block 820). In the illustrated example, the monitored network device data receiver 510 receives the monitored network device data from the monitored network devices 160. For example, an on-device meter operating on the monitored network device 160 may transmit the monitored network device data to the monitored network device data receiver 510. As described above, the network communications data may be transmitted in any other fashion. While, in the illustrated example, the monitored network device data receiver 510 receives the monitored network device data directly from the monitored network device 160, the monitored network device data receiver 510 may receive the monitored network device data indirectly from the monitored network device 160. For example, the monitored network device data receiver 510 may receive the monitored network device data from a monitored network device data server (e.g., a server that receives and/or stores on-device monitor data).

The communications comparator 530 then filters the network communications data stored in the network communications data store 115 based on the monitored device communications data stored in the monitored device communications data store 120 to create a subset of communications representing communications from the unmonitored network devices 150 (block 830).

The communications analyzer 540 then analyzes the subset of communications representing communications from the unmonitored network devices 150 to identify media presentation devices (block 840). In the illustrated example, the example communications analyzer 540 analyzes the communications from the unmonitored network devices 150 to determine ownership and/or usage statistics of the unmonitored network devices 150. However, in some examples, the example communications analyzer 540 may additionally or alternatively analyze the communications to determine relative rankings of usage and/or ownership of unmonitored network devices 150, types of uses of unmonitored network devices 150 (e.g., whether a device is used for browsing the Internet, streaming media from the Internet, etc.), and/or other types of unmonitored network device information.

FIG. 9 is a block diagram of an example processor platform 900 capable of executing the example machine-readable instructions of FIGS. 6-8 to implement the example network activity measurement system 110 of FIGS. 1 and 5 and/or the example network communications monitor 180 of FIGS. 1 and 4. The example processor platform 900 can be, for example, a server, a personal computer, an Internet appliance, a set top box, or any other type of computing device.

The example processor platform 900 of the instant example includes a processor 912. For example, the processor 912 can be implemented by one or more Intel® microprocessors from the Pentium® family, the Itanium® family or the XScale® family. Of course, other processors from other families are also appropriate.

The processor 912 is in communication with a main memory 914 including a volatile memory 918 and a non-volatile memory 920 via a bus 922. The volatile memory 918 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 922 may be implemented by flash memory and/or any other desired type of memory device. Access to the main memory 914 is typically controlled by a memory controller (not shown).

The computer 900 also includes an interface circuit 924. The interface circuit 924 may be implemented by any type of interface standard, such as an Ethernet interface, a universal serial bus (USB), and/or a PCI express interface.

One or more input devices 926 are connected to the interface circuit 924. The input device(s) 926 permit a user to enter data and commands into the processor 912. The input device(s) can be implemented by, for example, a keyboard, a mouse, a touchscreen, a track-pad, a trackball, isopoint and/or a voice recognition system.

One or more output devices 928 are also connected to the interface circuit 924. The output devices 928 can be implemented, for example, by display devices (e.g., a liquid crystal display, a cathode ray tube display (CRT), a printer and/or speakers). The interface circuit 924, thus, typically includes a graphics driver card.

The interface circuit 924 also includes a communication device (e.g., the network communicator 315, the network communicator 405, etc.) such as a modem or network interface card to facilitate exchange of data with external computers via a network (e.g., an Ethernet connection, a digital subscriber line (DSL), a telephone line, coaxial cable, a cellular telephone system, etc.).

The computer 900 also includes one or more mass storage devices 930 for storing software and data. Examples of such mass storage devices 930 include floppy disk drives, hard drive disks, compact disk drives and digital versatile disk (DVD) drives. The mass storage device 930 may implement the network communications data store 115, the monitored device communications data store 120, and/or the network communications data store 440.

The coded instructions 932 of FIGS. 6-8 may be stored in the mass storage device 930, in the volatile memory 918, in the non-volatile memory 920, and/or on a removable storage medium such as a CD or DVD.

From the foregoing, it will be appreciated that the above disclosed systems, methods, apparatus and articles of manufacture allow media presentation devices communicating on a network to be identified without requiring an on-device meter for those devices.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method of identifying a media presentation device, the method comprising:
accessing a first data set of network communications representing network communications of at least one media presentation device monitored by a network communications monitor;
accessing a second data set of network communications representing monitored network communications of at least one monitored media presentation device monitored by an on-device meter;
removing data from the first data set based on data in the second data set to create a third data set, the third data set representing communications of at least one unmonitored media presentation device; and
analyzing the third data set to identify the at least one unmonitored media presentation device.

2. The method as described in claim 1, wherein the second data set of network communications is received from the on-device meter.

3. The method as described in claim 1, wherein the network communications monitor monitors network communications of the at least one media presentation device at a location.

4. The method as described in claim 3, wherein the location is a local area network.

5. The method as described in claim 3, wherein the location is a media exposure measurement location.

6. A tangible machine-readable medium, storing instructions which, when executed, cause a machine to at least:
access a first data set of network communications representing network communications of at least one media presentation device monitored by a network communications monitor;
access a second data set of network communications representing monitored network communications of at least one monitored media presentation device;
filter the first data set based on the second data set to create a third data set, the third data set representing communications of at least one unmonitored media presentation device; and
analyze the third data set to identify the at least one unmonitored media presentation device.

7. The machine-readable medium as described in claim 6, wherein the at least one monitored media presentation device is monitored by an on-device meter.

8. The machine-readable medium as described in claim 7, wherein the second data set of network communications is received from the on-device meter.

9. The machine-readable medium as described in claim 6, wherein the network communications monitor monitors network communications of the at least one media presentation device at a location.

10. The machine-readable medium as described in claim 9, wherein the location is a local area network.

11. The machine-readable medium as described in claim 9, wherein the location is a media exposure measurement location.

12. A system to identify communications of a media presentation device, the system comprising:
an on-device meter to monitor network communications of a monitored media presentation device;
a network communications monitor to monitor the network communications of an monitored media presentation device and network communications of the at least one unmonitored media presentation device; and
a network activity measurement system to receive the monitored network communications of the monitored media presentation device as a first data set and the monitored network communications of the monitored media presentation device and the at least one unmonitored media presentation device as a second data set, the network activity measurement system to filter the second data set based on the first data set to create a third data set, the third data set representing communications of the at least one unmonitored media presentation device.

13. The system as described in claim 12, further comprising a network gateway, wherein the network gateway is interposed between (a) the network communications monitor and (b) the monitored media presentation devices and the at least one unmonitored media presentation device.

14. The system as described in claim 12, further comprising a network gateway, wherein the network communications monitor is interposed between (a) the network gateway and (b) the monitored media presentation devices and the at least one unmonitored media presentation device.

15. The system as described in claim 12, wherein the network communications monitor, the monitored media presentation device, and the at least one unmonitored media presentation device are located at a media exposure measurement location.

16. The system as described in claim 15, wherein the network activity measurement system is not located at the media exposure measurement location.

17. The system as described in claim 15, wherein the media exposure measurement location is a local area network.
